(19) United States
(12) Patent Application Publication
(10) Pub. No.: US 2025/0386441 A1
(43) Pub. Date: Dec. 18, 2025

(54) SUPPORT ASSEMBLY FOR ELECTRICAL INSTALLATIONS

(71) Applicant: ERICO International Corporation, Solon, OH (US)

(72) Inventor: Scott Ernest Anderson, Garrettsville, OH (US)

(21) Appl. No.: 19/219,929

(22) Filed: May 27, 2025

Related U.S. Application Data
(60) Provisional application No. 63/661,513, filed on Jun. 18, 2024.
(60) Provisional application No. 63/779,792, filed on Mar. 28, 2025.

(51) Int. Cl. H05K 5/02; H02B 1/46

(52) U.S. Cl. CPC H05K 5/0204; H02B 1/46

(57) ABSTRACT

A support assembly is provided for electrical installations. The support assembly includes a bracket. The bracket can include a support body and a clamp arm. The support body can include one or more first slots and one or more second slots that extend non-parallel to the one or more first slots. The clamp arm can extend integrally from the support body and can be configured to clamp the bracket to a support structure. The one or more first slots can receive one or more first fasteners and the one or more second slots can receive one or more second fasteners. The one or more first fasteners and the one or more second fasteners can be slidably adjustable along the one or more first slots and the one or more second slots, respectively, to secure an electrical component to the bracket.

### CROSS-REFERENCE TO RELATED APPLICATIONS

This application claims priority to U.S. Provisional Patent Application No. 63/661,513, filed on June 18, 2024, and U.S. Provisional Patent Application No. 63/779,792, filed on March 28, 2025, the entirety of which are incorporated by reference.

### BACKGROUND

Various electrical installations may require support of electrical components. For example, power switch assemblies for equipment can be used to control (e.g., connect or cut) power delivery to equipment. In some installations, power switch assemblies may need to be supported near the corresponding equipment.

### SUMMARY

Some embodiments of the disclosure provide a power switch assembly for equipment. The power switch assembly can include a switch bracket. The switch bracket can include a first side, a second side, one or more first slots, one or more second slots extending non-parallel to the one or more first slots, and an integrally formed c-shaped clamp at a first end of the switch bracket. Each of the one or more first slots can support at least one first fastener. Each of the one or more second slots can support at least one second fastener. The at least one first fastener and the at least one second fastener can be slidable along the one or more first slots and the one or more second slots, respectively.

Some embodiments of the disclosure provide a support assembly for electrical installations with a bracket. The bracket can include a support body and a clamp arm. The support body can include one or more first slots and one or more second slots. The one or more second slots can extend non-parallel to the one or more first slots. The clamp arm can extend integrally from the support body and can be configured to clamp the bracket to a support structure. The one or more first slots can receive one or more first fasteners and the one or more second slots can receive one or more second fasteners. The one or more first fasteners and the one or more second fasteners can be slidably adjustable along the one or more first slots and the one or more second slots, respectively, to secure an electrical component to the bracket.

In some examples, the support assembly can further include the electrical component, and the electrical component can include one or more first apertures spaced apart from one or more second apertures by any of a range of distances. The one or more first fasteners and the one or more second fasteners can be slidable along the one or more first slots and the one or more second slots, respectively, to secure the electrical component to the bracket via alignment of the one or more first apertures and the one or more second apertures with the one or more first fasteners and the one or more second fasteners, respectively, at any of the range of distances. In some examples, the electrical component may be a power switch box.

In some examples, the one or more first slots can include one or more substantially horizontal slots and the one or more second slots can include one or more substantially vertical slots.

In some examples, the one or more first slots can include a plurality of first slots and can be located along the support body between the one or more second slots and the clamp arm. In some examples, the one or more second slots can include only a single second slot.

In some examples, the bracket can include an upper portion and a lower portion that includes the clamp arm. The clamp arm can extend away from the support body to define a lower surface that seats on a horizontal support structure to support the bracket relative to the horizontal support structure. The one or more first slots can be included on the lower portion and the one or more second slots can be included on the upper portion. In some examples, the upper portion can be narrower than the lower portion in a direction parallel with an elongate direction of the one or more first slots. In some examples, the support body can extend at a lower end onto a lip that is opposite from, and angles towards, the clamp arm.

In some examples, the clamp arm can include a first aperture and can be configured to clamp the bracket to a horizontal support structure. An anchor feature can extend integrally from the support body and include a second aperture. The first and second apertures can be aligned to receive a vertical support structure to support the bracket relative to the vertical support structure. In some examples, the support body can include a mounting stop that protrudes to be aligned with the first and second apertures, to block movement of the vertical support structure, through the first and second apertures, past an installed orientation. In some examples, the clamp arm can support a set screw opposite the support body to selectively: secure the horizontal support structure against the support body, or secure the vertical support structure within the first aperture.

In some examples, the support body can further include device cutout spaced laterally apart from the one or more first slots and the one or more second slots. The device cutout can be configured to secure an electrical device to the support body adjacent to the electrical component.

In some examples, the claim arm and the support body can collectively define a c-shaped clamp with an inwardly protruding lip.

Some embodiments of the disclosure provide a support assembly for electrical installations. The support assembly can include a bracket and fasteners. The bracket can include one or more first slots, one or more second slots that can extend transverse to the one or more first slots, and a first anchor feature with a first aperture. The fasteners can be received in the one or more first slot and the one or more second slots and can be slidably movable along the one or more first slots and the one or more second slots to selectively secure an electrical component having any of a plurality of different patterns of mounting holes that receive the fasteners. The bracket can be selectively securable to support the electrical component with the bracket in a first support configuration or with the bracket in a second support configuration. In the first support configuration, the bracket can engage a first support member, via clamping engagement of the first anchor feature with the first support member, to support the one or more electrical components relative to the first support member. In the second support configuration, the bracket can receive a second support member through the first aperture to support the one or more electrical components relative to the second support member. The first support member can extend along a first direction. The second support member can extend along a second direction transverse to the first direction.

In some examples, the bracket can further include a second anchor feature with a second aperture. The second aperture can be spaced from the first anchor feature along the second direction and can align the second aperture to also receive the second support member in the second support configuration.

In some examples, the first anchor feature can include a clamp arm extending integrally from a support plate. The support plate can extend to a first end that includes an angled lip aligned opposite the clamp arm to engage the first support member in the first support configuration.

In some examples, the first anchor feature can include a clamp arm that protrudes from a support body of the bracket to support a set screw. The set screw can be aligned to clamp the first support member against the support body in the first support configuration and to clamp the second support member within the first aperture in the second support configuration.

Some embodiments of the disclosure provide a method of installing a support assembly for electrical installations. The method can include slidably moving fasteners within one or more first slots and one or more second slots of a bracket to selectively secure one or more electrical components having different patterns of mounting holes that receive the fasteners, the one or more second slots extending transverse to the one or more first slots, and selectively securing the bracket to support the one or more electrical components with the bracket in a first support configuration or with the bracket in a second support configuration. In the first support configuration, the bracket can engage a first support member that extends along a first direction, via clamping engagement of a first anchor feature of the bracket with the first support member, to support the one or more electrical components relative to the first support member. In the second support configuration, the bracket can receive a second support member through a first aperture of the first anchor feature, the second support member extending along a second direction transverse to the first direction, to support the one or more electrical components relative to the second support member.

In some examples, securing the bracket in the first support configuration can include tightening a set screw supported by a clamp arm of the first anchor feature to secure the first support member against a support body of the bracket. Securing the bracket in the second support configuration can include tightening the set screw to secure the second support member against an edge wall of the first aperture.

### BRIEF DESCRIPTION OF THE DRAWINGS

The accompanying drawings, which are incorporated in and form a part of this specification, illustrate examples of the disclosed technology and, together with the description, serve to explain the principles of examples of the disclosed technology:

FIG. 1 illustrates a support bracket, configured as a bracket of a power switch assembly, according to some aspects of the disclosure;

FIG. 2 illustrates another view of the bracket of FIG. 1;

FIG. 3 illustrates another support bracket, configured as a bracket of a power switch assembly, according to some aspects of the disclosure;

FIG. 4 illustrates another view of the bracket of FIG. 3;

FIG. 5 illustrates a power switch assembly with the bracket of FIG. 1, according to some aspects of the disclosure;

FIG. 6 illustrates another view of the power switch assembly of FIG. 5;

FIG. 7 illustrates a power switch assembly with the bracket of FIG. 3, according to some aspects of the disclosure;

FIG. 8 illustrates another view of the power switch assembly of FIG. 7;

FIGS. 9A and 9B illustrate stages of installation of a support bracket, according to some aspects of the disclosure;

FIGS. 10A-10C illustrate installed configurations of the support bracket of FISG. 9A and 9B, according to some aspects of the disclosure;

FIG. 11 illustrates the power switch assembly of FIG. 5 installed on a ground-mounted support structure;

FIG. 12 illustrates the power switch assembly if FIG. 5 installed on a wall-mounted support structure;

FIG. 13 illustrates another support bracket, configured as a bracket of a power switch assembly, according to some aspects of the disclosure;

FIG. 14 illustrates another view of the bracket of FIG. 13;

FIG. 15 illustrates the bracket of FIG. 13 installed in a horizontal mounting configuration;

FIG. 16A illustrates the bracket of FIG. 13 installed in a vertical mounting configuration;

FIG. 16B illustrates the bracket of FIG. 13 installed in another vertical mounting configuration;

FIG. 17 illustrates another support bracket, configured as a bracket of a power switch assembly, according to some aspects of the disclosure; and

FIG. 18 illustrates another view of the bracket of FIG. 17.

### DETAILED DESCRIPTION

Before any examples of the disclosed technology are explained in detail, it is to be understood that the disclosure is not limited in its application to the details of construction and the arrangement of components set forth in the following description or illustrated in the following drawings. The disclosure is capable of other examples and of being practiced or of being carried out in various ways.

The following discussion is presented to enable a person skilled in the art to make and use examples of the disclosed technology. Various modifications to the illustrated examples will be readily apparent to those skilled in the art, and the generic principles herein can be applied to other examples and applications without departing from the disclosed technology. Thus, the disclosed technology is not intended to be limited to examples shown, but are to be accorded the widest scope consistent with the principles and features disclosed herein. The following detailed description is to be read with reference to the figures, in which like elements in different figures have like reference numerals. The figures, which are not necessarily to scale, depict selected examples and are not intended to limit the scope of disclosed technology. Skilled artisans will recognize the examples provided herein have many useful alternatives and fall within the scope of the disclosed technology.

In various installations, equipment can be installed to be supported by a support structure. For example, HVAC units, heat pumps, air conditioning units, or other electronic equipment can be installed onto various building structures (e.g., walls, rooftop structures, etc.) or in other locations. In different contexts, some equipment can be installed on a wall (e.g., to be supported by a support bracket relative to a vertical or other wall structure), and some equipment can be installed on the ground (e.g., supported on the earth, or supported on the ground surface of a rooftop or other building structure).

Various types of electrical equipment may require a power switch (e.g., an electronic power disconnect switch) or other separate electrical assembly (e.g., support assembly) to be mounted at or near to the equipment. For example, some arrangements for air conditioning units may require a power disconnect switch to be located within a particular distance from the air conditioning unit. For example, the power switch may need to be activated/de-activated before the equipment can be serviced. Conventional methods of installing power disconnects switches and other similar assemblies can require customized arrangements or operations that may be inconvenient or time consuming for installers and may increase the difficulty of quickly installing power switches (or other devices) in desired locations .

As well as complicating installation generally, conventional approaches may not readily accommodate different sizes of power switches, which may vary depending on the size of the corresponding equipment or other factors. For example, a power switch required for a wall mounted air conditioner may be a different size than a power switch required for a ground mounted air conditioner.

Some examples of the disclosed technology can address these or other issues. For example, some configurations include a support assembly for electrical equipment (e.g., with corresponding integrally formed bracket) that can be quickly and securely mounted to a mounting structure for equipment (e.g., a wall-mounted bracket or ground-mounted support structure that the equipment is installed on). In some examples, a support bracket may be mountable to be entirely supported by the corresponding mounting structure, i.e., not separately secured to the corresponding building structure. Relatedly, some examples can allow pre-fabrication of a switch assembly, with a switch box or other device(s) pre-attached to an adaptable switch bracket (e.g., as a particular example of a support bracket as discussed above and below). The preassembled components can then be collectively attached to the relevant on-site support structure (e.g., as may allow flexible pre-fabrication of multiple assemblies for a job-site at an off-site location).

In some examples, a support bracket includes a lower portion. In some examples, the lower portion includes one or more first slots that can slidably support one or more first fasteners, for variable-position engagement with one or more apertures or other attachment structures (e.g., posts) on a lower portion of a power switch box. In some examples, the lower portion includes two slots that can support two first fasteners (e.g., rivet nuts). In some examples, the one or more (e.g., two) first slots extend in a horizontal (or substantially horizontal) direction, relative to an installed orientation of the support bracket. Alone or in combination with particular configurations of one or more second slots (e.g., as further discussed below), the inclusion of the one or more first slots can accommodate various sizes of a switch box or a switch assembly generally (e.g., corresponding to various spacings of attachment structures across a width of a switch box).

Similarly, in some examples, the support bracket includes an upper portion. In some examples, the upper portion includes one or more second slots that can slidably support one or more second fasteners for variable-position engagement with one or more apertures or other attachment structures on an upper portion of a power switch box. In some examples, the upper portion includes a single second slot that can support a single second fastener (e.g., a third rivet nut). In some examples, the one or more second slots extend in a vertical (or substantially vertical) direction, relative to an installed orientation of the support bracket. (e.g., parallel to the orientation of the support bracket when installed) to accommodate various sizes of the switch assembly. Alone or in combination with particular configurations of one or more first slots (e.g., as discussed above), the inclusion of the one or more second slots can accommodate various sizes of a switch box or a switch assembly generally (e.g., corresponding to various vertical locations of an upper attachment structure of a switch box, relative to one or more lower attachment structures).

In some examples, the support bracket includes one or more anchor features to secure the support bracket to electrical equipment, or to a support structure for the electrical equipment. In some examples, the support bracket includes a single anchor feature. In other examples, the support bracket includes two anchor features. In some examples, an anchor feature can be a clamp arm of a c-shaped or other clamp (e.g., with an inwardly angled lip and an opposing set screw). In some examples, the one or more anchor features are integrally formed with the support bracket (e.g., as an extension from a lower portion of a stamped planar plate). In some examples, a clamp arm formed on a support bracket can extend to a first side of the support bracket that is opposite a second side of the support bracket to which a switch box or other component is mounted (and on which that component protrudes).

In some examples, an anchor feature can include an aperture or other mounting feature to allow adaptable installation in horizontal, vertical, or other mounting configurations. For example, an aperture may extend through a side of a clamp (or other) anchor feature, to receive a support oriented transverse to the support axis of the clamp. In some installations, the clamp can accordingly be used selectively to secure a bracket to a horizontal (or other) support member or to a vertical (or other transverse) support member. For example, a clamp of an anchor feature may be thus used to clamp onto a horizontal bar (e.g., square tubing) whereas an aperture (e.g., through the clamp) may be oriented to receive a vertical tube (or strut, etc.). In some cases, multiple aligned apertures can be provided, or one or more stops can be included, to further improve engagement with a vertical (or other) support members.

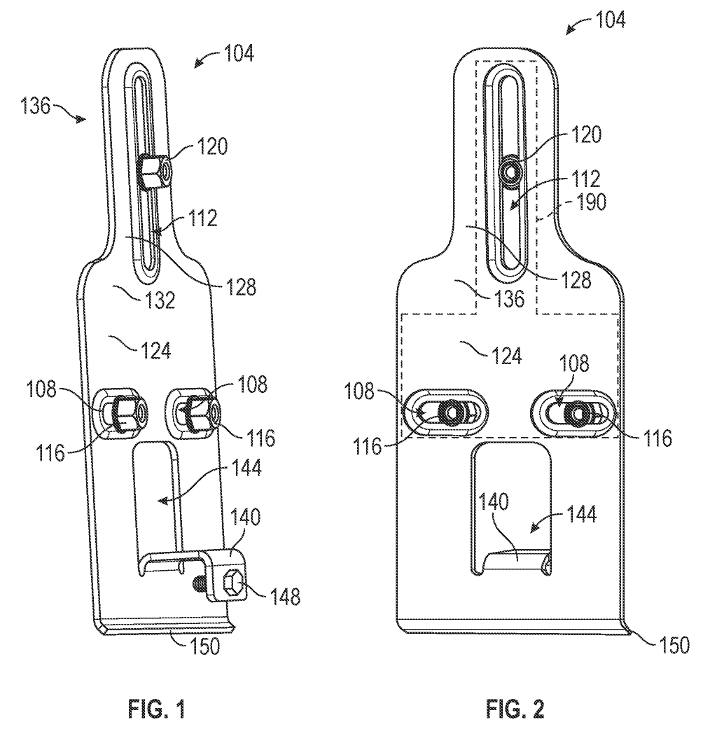

FIGS. 1 and 2 illustrate an example support bracket for an electrical device (e.g. power switch assembly) configured in particular as a switch bracket 104. The switch bracket 104 includes two first slots 108 that define respective first ranges of fastening locations and one second slot 112 that defines a second range of fastening openings. Thus, as further detailed below, via sliding adjustment of fasteners along the slots 108, 112, the bracket 104 can secure an electrical component having any of a plurality of different patterns of mounting holes that receive the fasteners. In other embodiments, different numbers of first slots or second slots can be included. Further, as generally noted above, other electrical components beside switch boxes can be similarly supported (e.g., by the bracket 104).

As shown in FIGS. 1 and 2, the first slots 108 are on a lower portion 124 of the switch bracket 104. In other embodiments, similar first slots may be otherwise located (e.g., on an upper portion 128 of the switch bracket 104). In the example shown, the upper portion 128 includes the second slot 112 and is a narrowed upper portion (i.e., defines structure that is narrower than the structure of the lower portion 124 relative to the elongate direction of the first slots 108, or otherwise along a narrowest width of each portion). In other embodiments, similar second slots may be otherwise located (e.g., on the lower portion 124 of the switch bracket 104), or bracket upper portions may not be narrowed relative to bracket lower portions.

In different examples, different fasteners can be slidably supported by (or otherwise engaged with) the first and second sets of slots, to allow adjustable positioning of the fasteners for support of electrical devices (e.g., switch boxes) with a variety of configurations. For example, as shown in FIGS. 1 and 2, the first and second slots 108, 112 each support a respective rivet nut. In particular, the first slots 108 receive first rivet nuts 116 and the second slot 112 receives a second rivet nut 120. In some embodiments, as shown in FIGS. 1 and 2, the first rivet nuts 116 or the second rivet nut 120 may be formed into axially-fixed but laterally-movable engagement with the first and second slots 108, 112, respectively.

The first and second rivet nuts 116, 120 may removably couple an electrical device or other component to the switch bracket. For instance, the first and second rivet nuts 116, 120 may removably couple an electrical component 190 to the switch bracket 104, as discussed in greater detail below. In some embodiments, the electrical component may be a power switch box, an outlet or other electrical device, an electrical box, an electrical shut-off, a power source, an electric vehicle charger or other charger, photovoltaic solar electronics or equipment, or various other electrical components known in the art).

As shown in FIGS. 1 and 2, nut portions of the first rivet nuts 116 and second rivet nut 120 are on a first side 132 of the switch bracket 104. In other embodiments, nut portions of the first and second rivet nuts 116, 120 can be on a second side 136 of the bracket 104, opposite the first side 132. In a preferred embodiment, the first and second rivet nuts 116, 120 are on the same side of the bracket 104. In such embodiments, the first and second rivet nuts 116, 120, in combination with the first and second slots 108, 112, may secure the electrical component 190 such that the electrical component 190 is flush to (e.g., secured directly without gaps, in direct contact with, etc.) the switch bracket 104. Specifically, the electrical component 190 may be removably secured (e.g., removably installed) and flush with a second side 136 of the bracket 104 since the first and second slots 108, 112 protrude from the first side 132. However, the first and second rivet nuts 116, 120 may be on different sides of the bracket 104 in some examples.

Generally, one or more first slots of a switch (or other) bracket can be oriented transversely to one or more second slots of the switch (or other) bracket. Correspondingly, one or more fasteners for the first slot(s) can be moved along a first direction to be aligned at a variety of positions on the bracket. Further, one or more fasteners for the second slot(s) can be moved along a second direction, transverse to the first direction, to be aligned at a variety of positions on the bracket – and with a corresponding variety of spacings relative to the one or more fasteners for the first slot(s). Thus, for example, a wide variety of fastener configurations for switch boxes or other electrical assemblies can be adaptably accommodated.

As shown in FIGS. 1 and 2, the first slots 108 may be oriented substantially horizontally (e.g., the first slots 108 may be configured to be horizontal slots), so that the corresponding rivet nuts 116 can move in a substantially horizontal direction. Additionally, as shown in FIGS. 1 and 2, the second slot 112 may be oriented substantially vertically (e.g., the second slot 112 may be configured to be a vertical slot, so that the corresponding rivet nut 120 can move in a substantially vertical direction. However, other orientations of the first and second slots 108, 112 are possible (e.g., the first slots may be transverse to horizontal and the second slot may be transverse to vertical).

As generally noted above, the orientation of the first and second slots 108, 112 advantageously allows the switch bracket 104 to accommodate various sizes of switch boxes (or other assemblies). In particular, the horizontal adjustment of the first rivet nuts 116 may accommodate various widths of an electrical component 190, including switch boxes, or various horizontal locations or spacings of one or more apertures (or other fastener structures) on a lower portion of the electrical component 190. Further, the vertical adjustment of the second rivet nut 120 may accommodate various heights of electrical component 190, or various vertical locations or spacings of one or more apertures (or other fastener structures) on an upper portion of the electrical component 190.

In some embodiments, a switch bracket may include one or more anchor features configured to secure the switch bracket to a support structure (e.g., a bracket, support frame, or other support structure that supports the corresponding electrical equipment). As shown in FIGS. 1 and 2, the example switch bracket 104 includes an anchor feature 140 configured as a cantilevered clamp arm of a c-shaped clamp. In particular, the anchor feature 140 is integrally formed with the bracket 104 and thus defines a corresponding aperture 144, as shown in FIGS. 1 and 2. As shown in FIGS. 1 and 2, the anchor feature 140 is on the lower portion 124 of the switch bracket 104, although other configurations are possible.

As also shown in FIGS. 1 and 2, the anchor feature 140 may include a set screw 148. For example, the set screw 148 can be supported on an arm of the anchor feature 140 that extends away from a main (e.g., plate) body of the switch bracket 104. Such an arrangement, e.g., in combination with an angled lip 150 opposite the set screw 148, can allow the switch bracket 104 to be quickly and reliably secured to the relevant mounting structure. For example, the relevant structure of the mounting system can be captured between the set screw and the opposed inwardly angled lip 150 of the integrally formed clamp structure. The lip 150 may extend from the stamped plate (e.g., the lower portion 124 of the bracket 104) at a first end (e.g., bottom end) of the bracket 104, opposite a second end (e.g., top end), where the second end proximately includes the second slot 112.

In some embodiments, such as shown in the example switch bracket 104, the anchor feature 140 may extend from the bracket 104, on the first side 132. In some embodiments, it may be advantageous to include an anchor feature 140 that extends on the first side 132, opposite from the second side 136 where an electrical component 190 is removably secured. Accordingly, removably securing the electrical component 190 is not hindered by the anchor feature. In other embodiments, the anchor feature 140 may extend from the bracket 104, on the second side 136, to provide an easier installation and removably securement of the bracket 104 to a mounting structure. In such embodiments, the lip 150 will also extend in the same direction from the bracket 104 as the anchor feature 140.

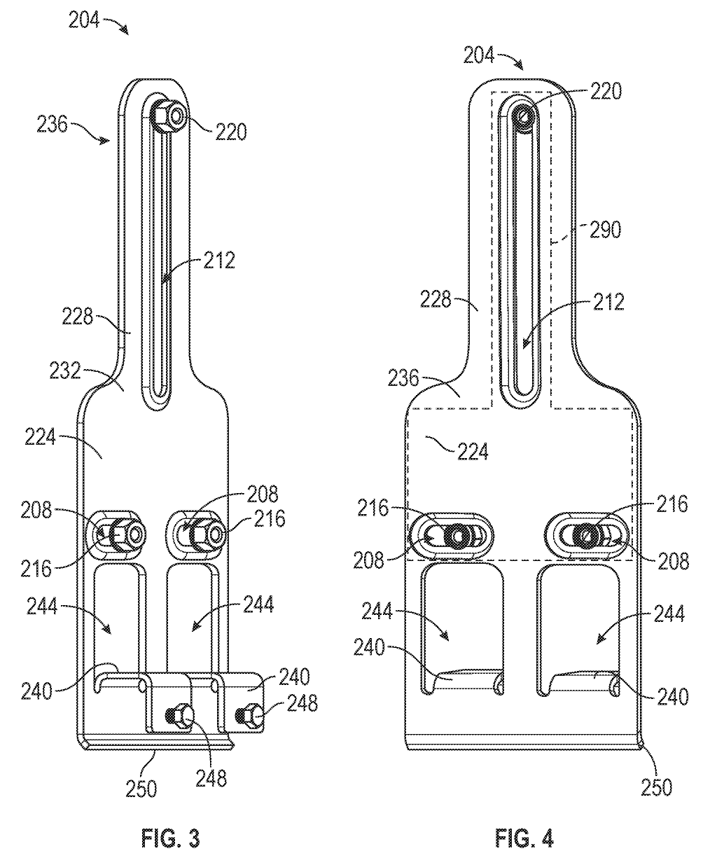

In some embodiments, a switch (or other) bracket may include multiple anchor features. For example, as shown in FIGS. 3 and 4, an example switch bracket 204 may include anchor features 240. The switch bracket 204 is similar to the switch bracket 104, with correspondingly similar numbering in the 200 series, and discussion of particular numbered features above thus applies to similarly numbered features below unless otherwise indicated. For example, as well as the anchor features 240, the switch bracket 204 includes a first side 232, second side 236, a lower portion 224, an upper portion 228, first slots 208 that slidably support first rivet nuts 216, a second slot 212 that slidably supports a second rivet nut 220 and extends transversely to the first slots 208, and an electrical component 290 that may be removably secured to the switch bracket 204. The anchor features 240, similar to the anchor feature 140, may be integrally formed with the switch bracket 204 and thereby define apertures 244 in a main (e.g., plate, lower portion 224) body of the switch bracket 204. Additionally, the anchor features 240 may each include a set screw 248 supported on an arm that extends opposite an angled lip 250, as can allow the respective anchor feature 240 to be securely and easily installed on a relevant support body (e.g., a strut, a pipe, or another building structure, etc.).

Still referring to FIGS. 3 and 4, the bracket 204 of FIGS. 3 and 4 is different from the bracket 104 of FIGS. 1 and 2 in some other aspects. For example, the bracket 204 is larger than the bracket 104 to accommodate larger sized power switches, as also discussed below. For example, the upper portion 228 of the bracket 204 may be longer than the upper portion 128 of the bracket 104. Thus, the second slot 212 of the bracket 204 may be longer than the second slot 112 of the bracket 104. Similarly, the lower portion 224 of the bracket 204 may be wider than the lower portion 124 of the bracket 104. Thus, the first slots 208 of the bracket 204 be longer in a width direction of the bracket 204 than the first slots 108 of the bracket 104. In some embodiments, the anchor features 240 of the bracket 204 may be larger than the anchor feature 140 of the bracket 104, to accommodate larger support structures for a switch box. However, the switch bracket 104 or other brackets disclosed herein may include more than one anchor feature (e.g., similar to the anchor features 240 of the bracket 204).

In different installations, various electrical devices can be secured to a bracket as variously described above. For some installations, a power switch box can be secured to a switch bracket, to provide a power switch assembly. In some embodiments, internal electrical components (e.g., wiring, controllers, circuit board, etc.) can be installed within a power switch box, and the power switch box can be secured to a switch bracket, before the power switch assembly is installed onto a support structure. Thus, for example, a pre-fabricator may preassemble a wide variety of configurations of a power switch box and switch bracket, along with necessary electrical components, before providing the assemblies for installation on a mounting system for electrical equipment or other support structure. Further, similar principles can be applied to pre-fabricate assemblies for a wide variety of other electrical components.

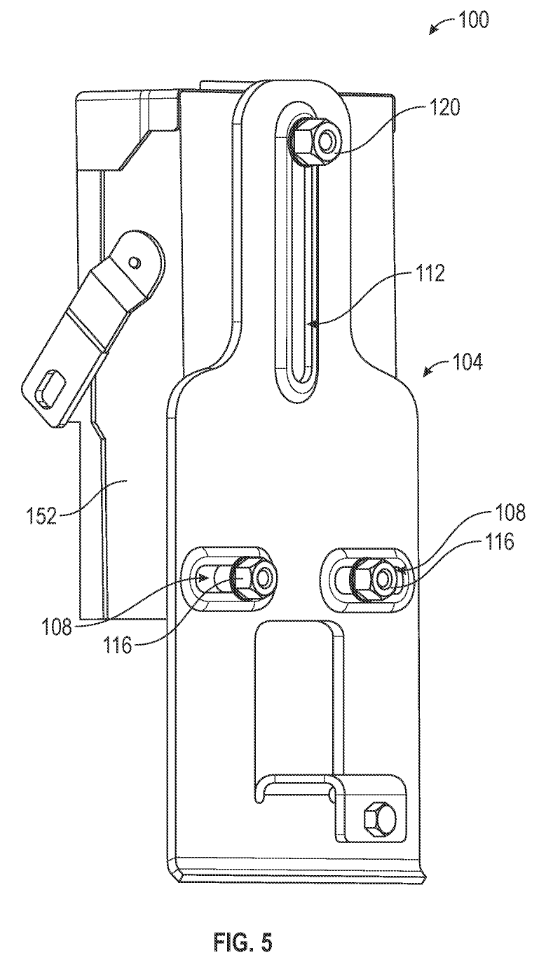

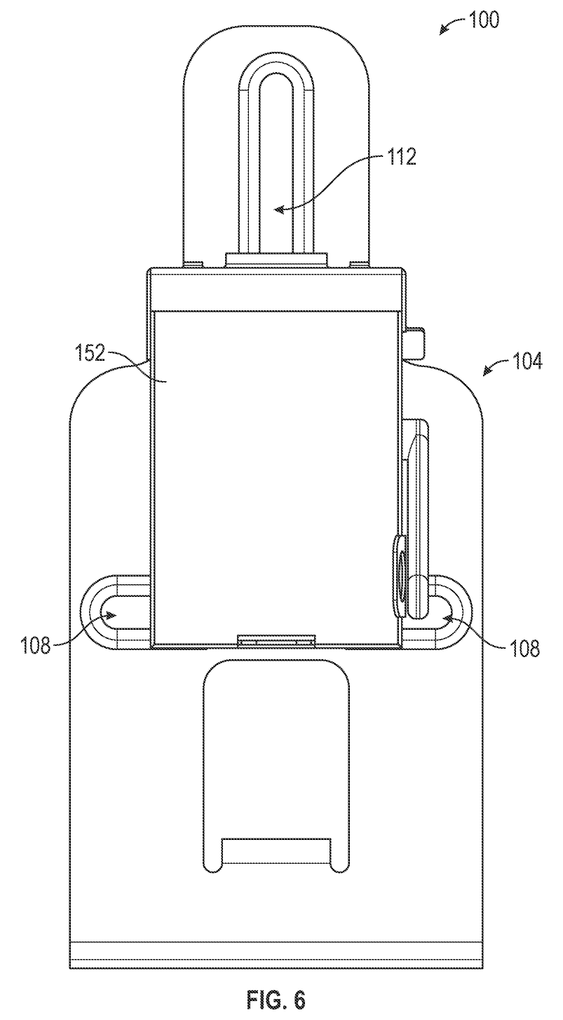

As one example, as shown in FIGS. 5 and 6, a power switch 152 is secured to the switch bracket 104 in a power switch assembly 100. In particular, the power switch box 152 is secured to the switch bracket 104 via the first and second rivet nuts 116, 120. As discussed above, the first and second rivet nuts 116, 120 can move within the respective first and second slots 108, 112 to accommodate the particular fastener arrangement (e.g., aperture spacing) of the power switch box 152 and thus easily secure the switch box 152 to the switch bracket 104. In the depicted example, and as discussed above, the switch assembly 100 may include the power switch box 152, removably secured to the switch bracket 104 so that the box 152 is flush with the bracket 104. As stated above, the power switch assembly 100 can be preassembled (e.g., electrical components installed or the power switch box secured to the switch bracket) before being installed.

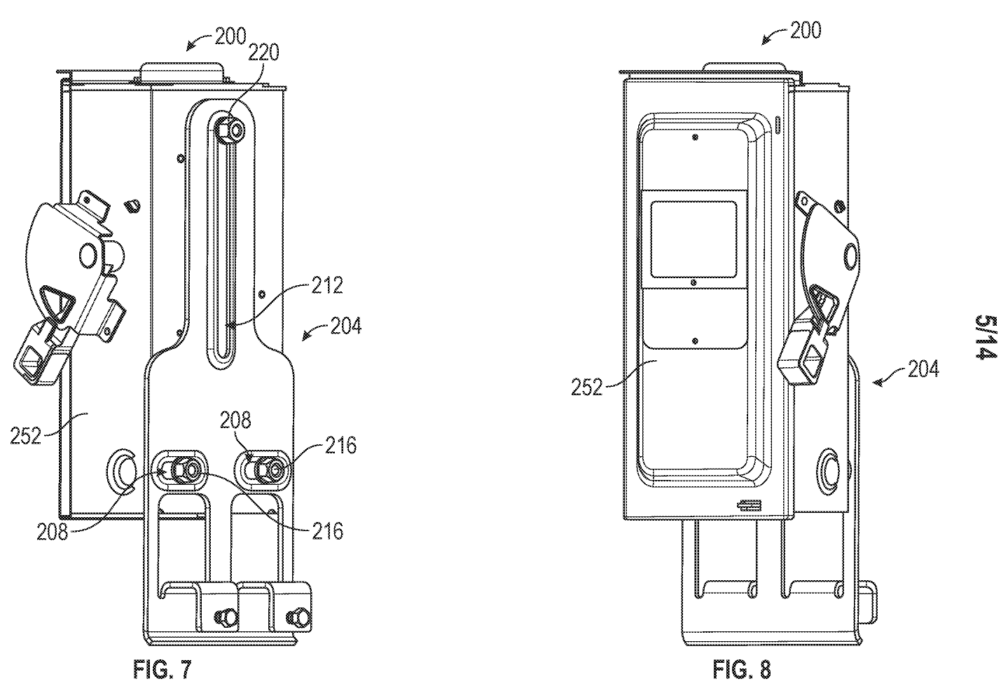

Similarly, as shown in FIGS. 7 and 8, a power switch box 252 is secured to the switch bracket 204 in a power switch assembly 200. In particular, the power switch 252 is secured to the switch bracket 204 via the first and second rivet nuts 216, 220. As discussed above, the first rivet nuts 216 and the second rivet nut 220 can move within the respective first and second slots 208, 212 to accommodate the particular configuration of the switch box 252 and thus easily secure the switch box 252 to the switch bracket 204. As also discussed above, the switch bracket 204 is larger than the switch bracket 104 and thus can accommodate the larger size of the power switch box 252 (relative to the power switch box 152). Similar to the switch assembly 100, the power switch box 252 can be removably secured to the switch bracket 204 such that the box 252 is flush with the bracket 204. As stated above, the power switch assembly 200 can be preassembled (e.g., electrical components installed or the power switch box secured to the switch bracket) before being installed.

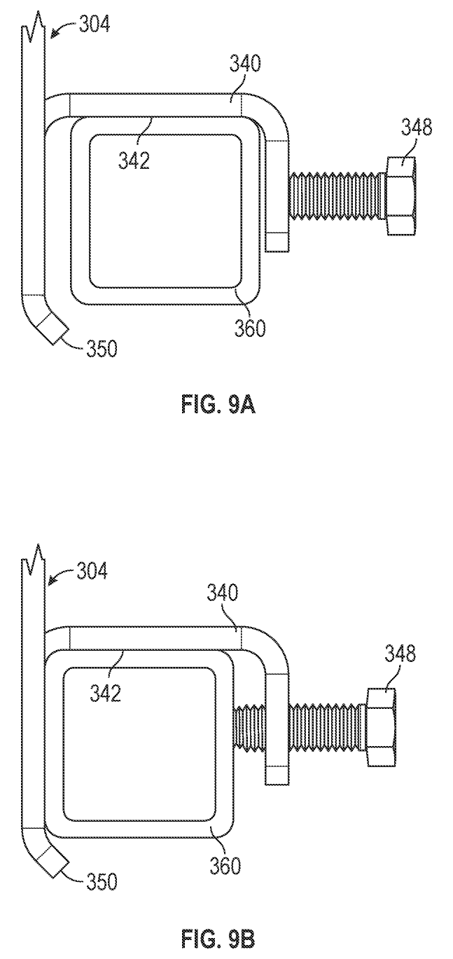

As discussed above, anchor features of the switch bracket can secure the switch bracket to a mounting system. In particular, the anchor features of some switch brackets can secure the switch brackets to support structures that also support the corresponding electrical equipment. For example, as shown in FIGS. 9A and 9B, an anchor feature 340 of a switch bracket 304 can be secured to a mounting component 360 of a mounting system (e.g., a square tube, as shown, of a larger support structure). The anchor feature 340 and the switch bracket 304, for example, can be specific implementations of the anchor feature 140 of the switch bracket 104, or either of the anchor features 240 of the switch bracket 204 and the above discussion of the anchor features 140, 240 and switch brackets 104, 204 is thus applicable to the anchor feature 340 and switch bracket 304 of FIGS. 9A and 9B (and vice versa). Further, the anchor feature 340 and the switch backet 304 can be a specific implementation of either of the anchor features 440 on switch bracket 404, or either of anchor features 540 on switch bracket 504, both of which are discussed in greater detail below.

In some examples, the mounting component 360 can be inserted into the anchor feature 340, as shown in FIG. 9A (e.g., by lowering the switch bracket 304 onto the mounting component 360). Thus, for example, a lower surface 342 of the anchor feature 340 (e.g., lower surface of a clamp arm, as shown) can seat on the mounting component 360 (e.g., sit flush on a horizontal top surface of a horizontal beam, as shown). Once inserted, the switch bracket 304 can be further secured by tightening a set screw 348, as shown in FIG. 9B, which may secure the mounting component 360 against removal past a lip 350 and force the mounting component 360 to contact a first side (e.g., similar to the first side 132, 232 of brackets 104, 204) of the bracket 304.

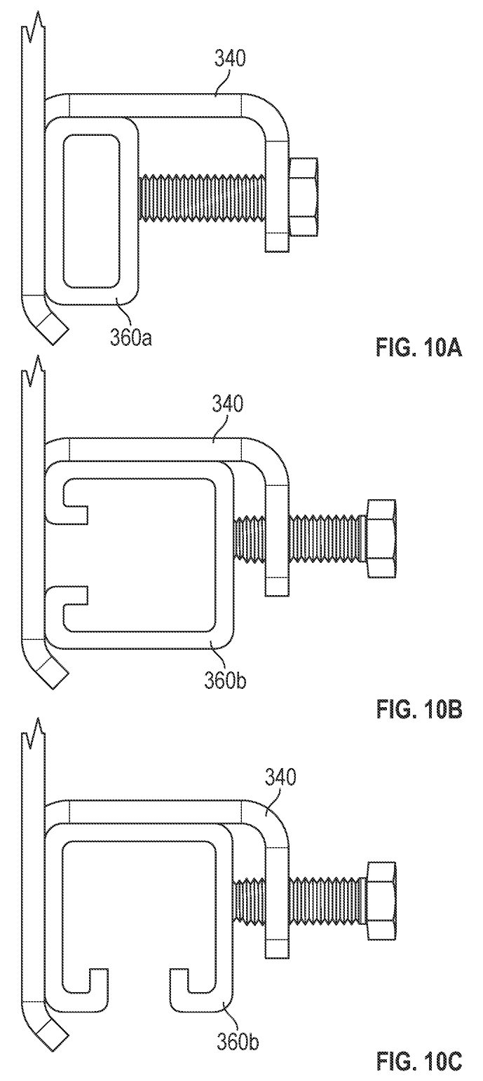

In some embodiments, the anchor feature 340 can receive a mounting component that is square in cross section (e.g., as shown in FIGS. 9A and 9B), although other configurations are possible. For example, a mounting component 360a may have a non-square rectangular cross-section, as shown in FIG. 10A. In other embodiments, a mounting component 360b may be a strut (e.g., a standard u-shaped strut channel), as shown in FIGS. 10B and 10C. Further, a mounting component can be engaged by an anchor feature to support the switch bracket in various relative orientations. For example, a switch bracket may be installed such that a rectangle mounting component is in rotated orientation relative to FIG. 10A (e.g., so that the set screw 348 contacts the shorter side of the mounting component 360a). Similarly, the anchor feature 340 can receive and secure the mounting component 360b in different rotational orientations, as shown in FIGS. 10B and 10C. Further, other mounting components may include other geometrical shapes or be installed in other orientations than those expressly shown.

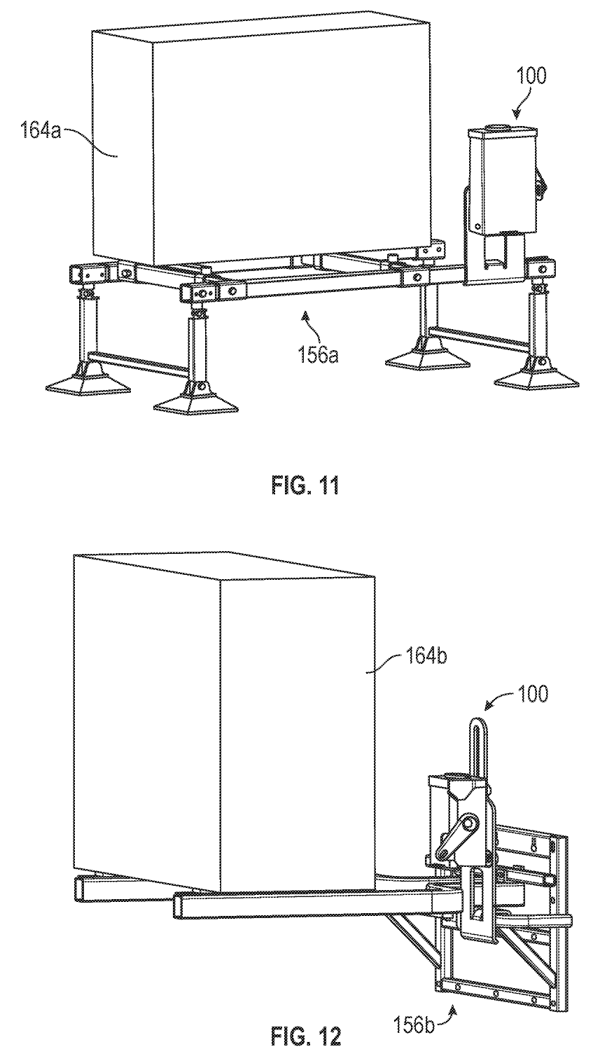

In some aspects of the disclosure, a power switch assembly can be installed on a ground-mounted mounting system. For example, the power switch assembly 100 can be installed on a ground-mounted support frame 156a that also supports electronic equipment 164a, as shown in FIG. 11. In the embodiment depicted in FIG. 11, the electronic equipment 164a is an air conditioner. In other embodiments, the electronic equipment 164a may be a heat pump, a water heater, an air handling unit, or the like. As stated above, in some cases, the power switch assembly 100 can be preassembled before being installed onto the support frame 156a (e.g., electrical components installed into a power switch box, and the power switch box secured to the switch bracket).

In some aspects of the disclosure, a power switch (or other) assembly can be installed on a wall-mounted mounting system. For example, the power switch assembly 100 can be installed on a wall-mounted bracket 156b that also supports electronic equipment 164b, as shown in FIG. 12. In the embodiment depicted in FIG. 12, the electronic equipment 164b is an air conditioner. In other embodiments, the electronic equipment 164b may be a heat pump, a water heater, an air handling unit, or the like. As stated above, in some cases, the power switch assembly 200 can be preassembled before being installed onto the bracket 156b (e.g., the electrical components installed into a power switch box, and the power switch box secured to the switch bracket).

As generally noted above, it may sometimes be advantageous for a power switch assembly (or other electrical or support assembly) to be capable of being installed to various transversely oriented support structures (e.g., in a vertical mounting configuration or a horizontal mounting configuration). To be installed in a vertical (or other) mounting configuration or a horizontal (or other transvers) mounting configuration, a bracket of the power switch assembly may include horizontal anchor features and vertical anchor features, to allow selective installation to different support structures (e.g., while maintaining the same overall orientation of the relevant bracket).

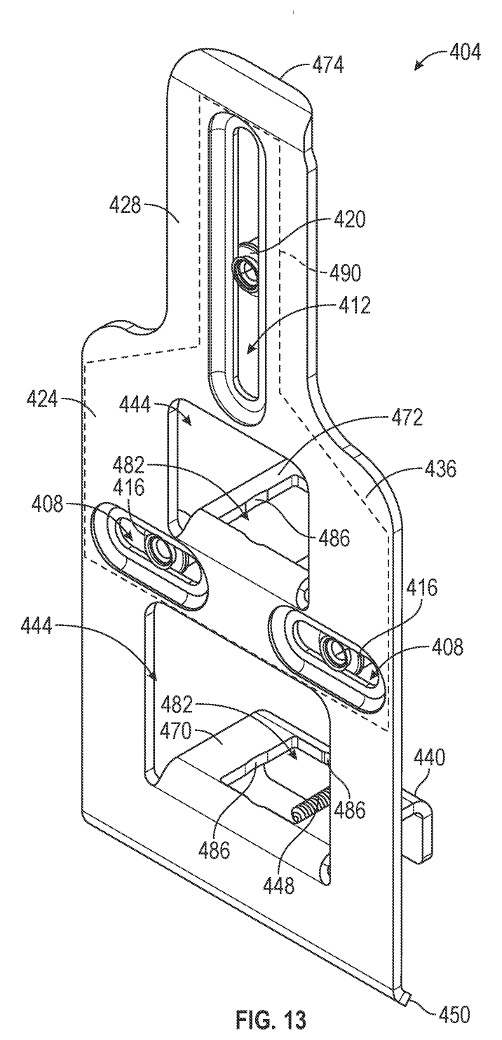

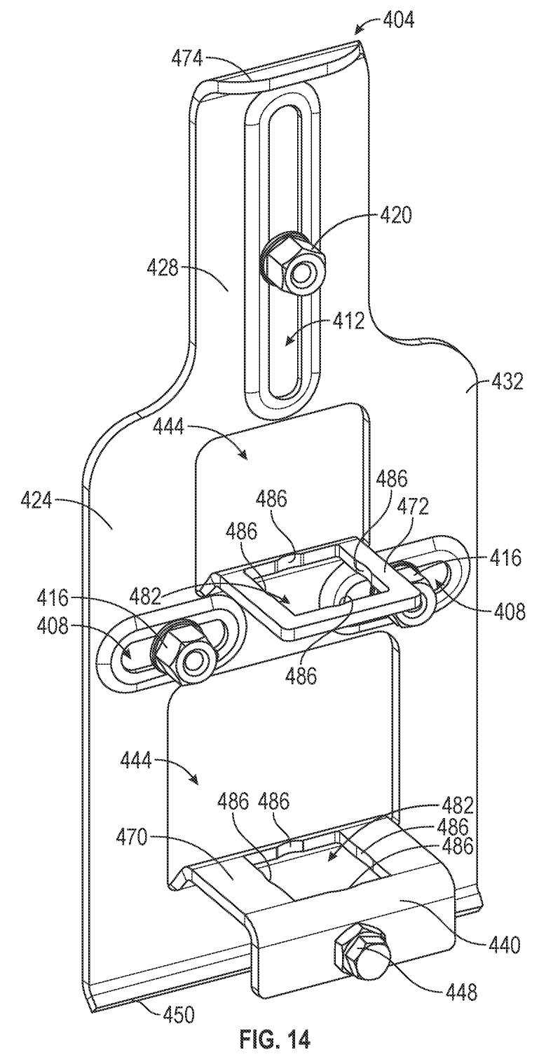

In some examples, a vertical anchor feature can include or define a corresponding aperture, including as part of a horizontal anchor feature. For example, as shown in FIG. 13 and FIG. 14, an example switch bracket 404 may include vertical anchor features 470, 472 that define apertures to receive a vertical (or other) support structure.

The switch bracket 404 is similar to the switch bracket 104 and 204, with correspondingly similar numbering in the 400 series, and discussion of particular numbered features above thus applies to similarly numbered features below unless otherwise indicated. For example, as well as the vertical anchor features 470, 472, the bracket 404 includes a first side 432, a second side 436, lower portion 424, an upper portion 428, apertures 444, horizontal anchor features 440 configured as c-shaped clamps, an angled lip 450, a set screw 448, first slots 408 that slidably support first rivet nuts 416, a second slot 412 that slidably supports a second rivet nut 420 and extends transversely to the first slots 408, and an electrical component 490 that may be removably secured to the switch bracket 404.

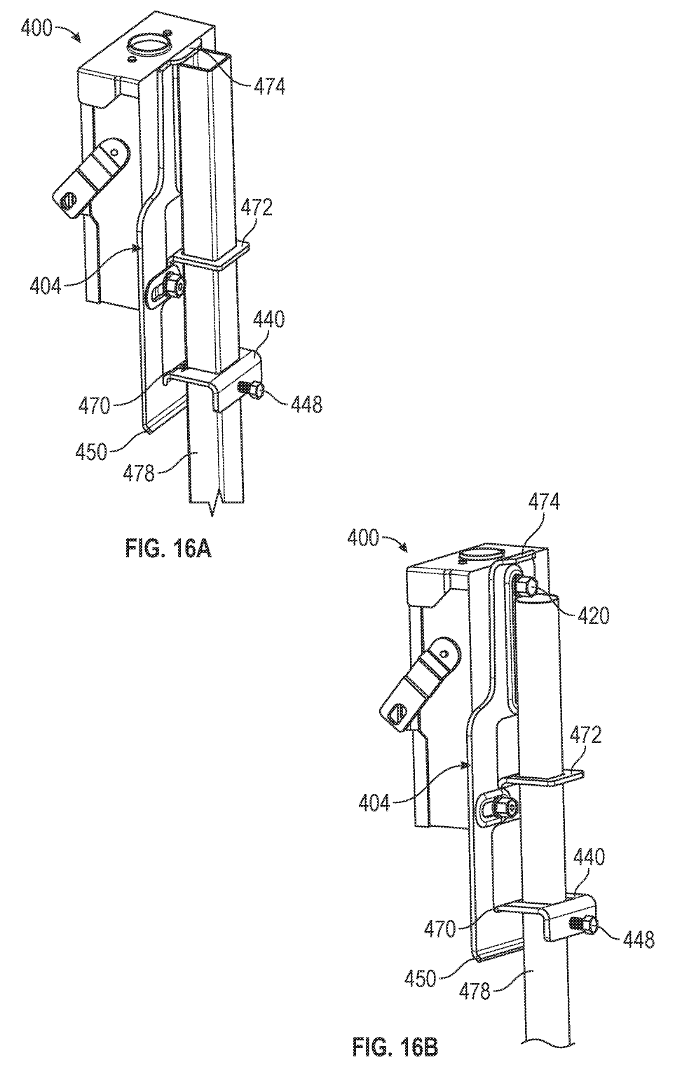

In the illustrated example, the vertical anchor feature 470 (e.g., first vertical anchor feature) can include a lower aperture formed as a cutout in the horizontal anchor feature 440. Similarly, the vertical anchor feature 472 (e.g., second vertical anchor feature) can be integrally formed from the bracket 404, at the top one of apertures 444 in the illustrated orientation, to include an upper aperture. The apertures of the vertical anchor features 470, 472 can be shaped to collectively receive, via vertical apertures 482, and simultaneously engage a strut, a pipe, or other support member for vertical mounting. With the support member thus received (e.g., as shown in FIGS. 16A and 16B), the set screw 448 can be tightened to secure the switch bracket 404 in place. For example, the anchor features 470, 472, each include cutouts 486 arranged around the apertures482. In some embodiments, such as FIGS. 13 and 14, the cutouts 486 are arranged around a periphery of the cutouts 486 such that one cutout 486 is on each side of the aperture 482.

Still referring to FIGS. 13 and 14, in further contrast to the bracket 204 of FIGS. 3 and 4, the bracket 404 includes the apertures 444, which are vertically spaced from one another (in the illustrated orientation), rather than horizontally spaced from one another. Additionally, the bracket 404 includes a mounting stop 474, formed in particular as a top lip, that can help to secure a vertical support member, as discussed in greater detail below. The mounting stop 474 may be spaced apart (e.g., vertically spaced) from the mounting feature 472, and, correspondingly, mounting feature 470. In some embodiments, the mounting stop 474 is at a second end, opposite a first end and opposite the lip 450, and, correspondingly, opposite the mounting feature 470.

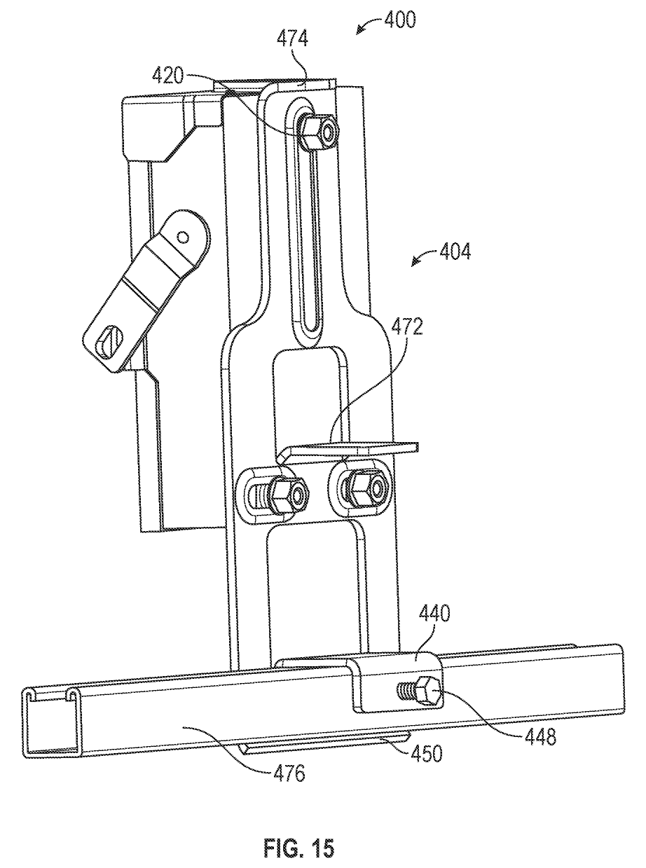

As shown in FIG. 15 and similarly discussed above, the bracket 404 can be secured by the set screw 448 to a horizontal support member 476 as part of a power switch assembly 400 (e.g., a horizontal support configuration). In an alternate installation configuration, the power switch assembly 400 can be secured to a vertical support member 478, as shown in FIG. 16A and FIG. 16B (e.g., a vertical support configuration). Thus, for example, the bracket 404 can be selectively secured in a variety of different support configurations to support an electrical component in a constant (e.g., upright) orientation relative to support members having different orientations (e.g., horizontal and vertical).

In different installations, various support members can be similarly engaged to provide high adaptability for installers. In FIG. 16A, for example, the support member 478 is a strut, and is secured via the set screw 448 and the mounting stop 474. In particular, with the strut concurrently received through the apertures of the vertical anchor features 470, 472, the mounting stop 474 contacts the end of the strut to block the bracket 404 from sliding down the support member 478 (e.g., with the strut at a corresponding installed orientation relative to the bracket 404). In FIG. 16B, the support member 478 is a pipe, and is secured via the set screw 448 and the second rivet nut 420, which also secures a switch box to the switch bracket 404. In particular, with the pipe concurrently received through the apertures 482 of the vertical anchor feature 470, 472 (e.g., and urged against one of the cutouts 486 by the set screw 448), the second rivet nut 420 contacts the end of the pipe to block the bracket 404 from sliding down the support member 478 (e.g., with the pipe at a corresponding installed orientation relative to the bracket 404). In contrast, referring again to FIG. 16A, the open side of the strut channel of the support member 478 may allow the rivet nut 420 to nest into the interior of the support member 478 (with the rivet nut 420 correspondingly hidden from view in FIG. 16A). In other examples, the set screw can otherwise urge a vertical (or other) support member into an edge wall of an aperture.

In some aspects of the disclosure, it may be advantageous for a power switch assembly to be capable of including multiple electrical components on a bracket. Specifically, it may be advantageous for a power switch assembly to readily support both a switch (or other) box and also an outlet or other electrical device (e.g., other electrical box and associated components). Some examples of the disclosed technology can correspondingly support a switch box and additional electrical components on a common bracket.

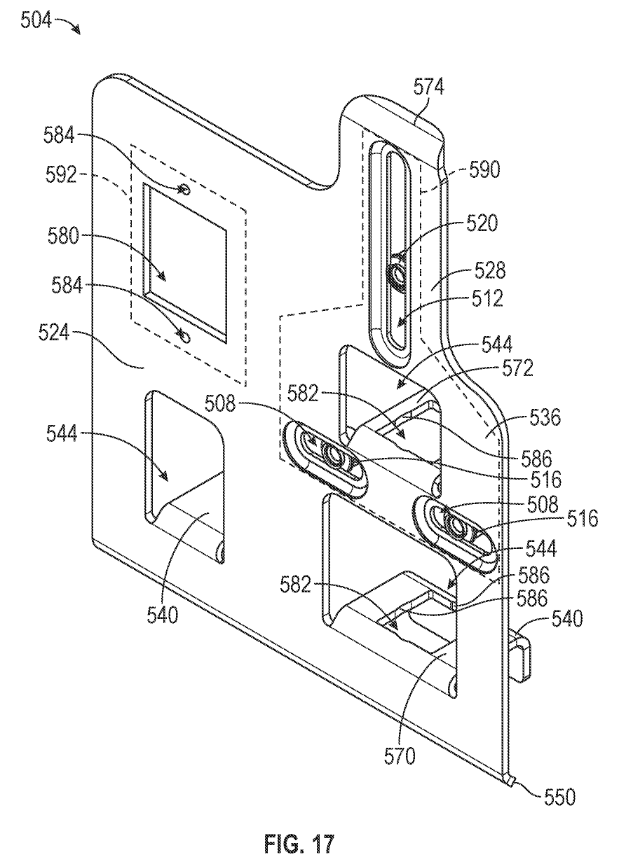

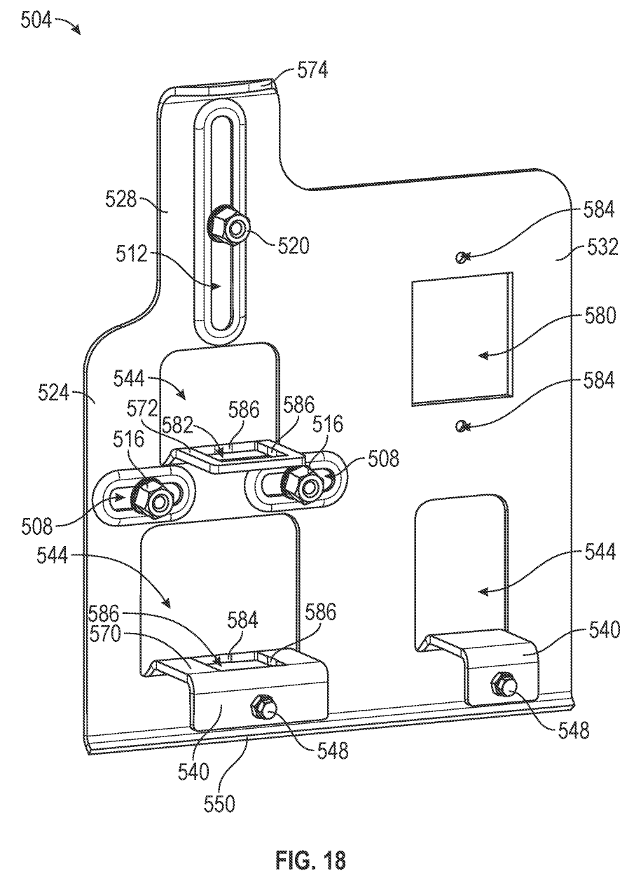

For example, as shown in FIG. 17 and FIG. 18, an example switch bracket 504 may include an outlet cutout 580 (or other device cutout) to secure an electrical device 592 (e.g., outlet, switch, etc.). The switch bracket 504 is similar to the switch brackets 104, 204, 404, with correspondingly similar numbering in the 500 series, and discussion of particular numbered features above thus applies to similarly numbered features below unless otherwise indicated. For example, as well as the outlet cutout 580 and corresponding electrical component 592, the bracket 504 includes first side 532, a second side 536, a lower portion 524, an upper portion 528, first slots 508 and corresponding rivet nuts 516, second slot 512 and rivet nut 520, apertures 544, horizontal anchor features 540, set screw 548, an angled lip 550, vertical anchor features 570, 572, a mounting stop 574, an electrical component 590 that may be removably secured to the switch bracket 504, apertures 582, and corresponding cutouts 586.

Additionally, the switch bracket 504 includes an additional horizontal anchor feature 540 that is formed via one of the apertures 544. With the two horizontal anchor features 540 engaged, the switch bracket 504 can thus support electrical components relative to a horizontal support member similarly to the switch bracket 204 (see FIG. 7). Further, the vertical anchor features 570, 572 can be alternatively used to secure the switch bracket 504 to a vertical support member, as similarly described for the switch bracket 404.

The switch bracket 504 also includes holes 584 above and below the outlet cutout 580 for mounting an outlet or other electrical device. In particular, the outlet cutout 580 is shown spaced laterally apart from the slots 508, 512, as well as vertically above the anchor feature 540. In other examples, other arrangements are possible (e.g., with differently shaped, located, or otherwise arranged mounting structures to secure the same or a different outlet or other electrical device).

Thus, examples of the disclosed technology can provide improved systems and methods for installing a power switch (or other) assembly onto a support system for electrical equipment, including for a ground-mounted configuration and a wall-mounted configuration. For example, as detailed above, some configurations can allow for simplified installation, and a more adaptable configuration relative to different types of equipment or installation locations.

It is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

Also as used herein, unless otherwise limited or defined, “substantially parallel” indicates a direction that is within ± 12 degrees of a reference direction (e.g., within ± 6 degrees or ± 3 degrees), inclusive. Similarly, unless otherwise limited or defined, “substantially perpendicular” similarly indicates a direction that is within ± 12 degrees of perpendicular a reference direction (e.g., within ± 6 degrees or ± 3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “only one of,” or “exactly one of.” For example, a list of “only one of A, B, or C” indicates options of: A, but not B and C; B, but not A and C; and C, but not A and B. In contrast, a list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more A, one or more B, and one or more C. Similarly, a list preceded by “a plurality of” (and variations thereon) and including “or” to separate listed elements indicates options of one or more of each of multiple of the listed elements. For example, the phrases “a plurality of A, B, or C” and “two or more of A, B, or C” indicate options of: one or more A and one or more B; one or more B and one or more C; one or more A and one or more C; and one or more A, one or more B, and one or more C.

Also as used herein, unless otherwise limited or defined, “integral” and derivatives thereof (e.g., “integrally”) describe elements that are manufactured as a single piece without fasteners, adhesive, or the like to secure separate components together. For example, an element that is stamped, cast, or otherwise molded as a single-piece component from a single piece of sheet metal or using a single mold, without rivets, screws, other fasteners, or adhesive to hold separately formed pieces together is an integral (and integrally formed) element. In contrast, an element formed from multiple pieces that are separately formed initially then later connected together, is not an integral (or integrally formed) element.

As used herein, unless otherwise limited or specified, “substantially identical” refers to two or more components or systems that are manufactured according to the same process and specification, with variation between the components or systems that are within the limitations of acceptable tolerances for the relevant process or specification. For example, two components can be considered to be substantially identical if the components are manufactured according to the same standardized manufacturing steps, with the same materials, and within the same acceptable dimensional tolerances (e.g., as specified for a particular process or product).

Also as used herein, unless otherwise limited or defined, “substantially parallel” indicates a direction that is within ± 12 degrees of a reference direction (e.g., within ± 6 degrees or ± 3 degrees), inclusive. Similarly, unless otherwise limited or defined, “substantially perpendicular” similarly indicates a direction that is within ± 12 degrees of perpendicular a reference direction (e.g., within ± 6 degrees or ± 3 degrees), inclusive. Correspondingly, “substantially vertical” indicates a direction that is substantially parallel to the vertical direction, as defined relative to the reference system (e.g., a local direction of gravity, by default), with a similarly derived meaning for “substantially horizontal” (relative to the horizontal direction). Discussion of directions “transverse” to a reference direction indicate directions that are not substantially parallel to the reference direction. Correspondingly, some transverse directions may be perpendicular or substantially perpendicular to the relevant reference direction.

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

In some implementations, devices or systems disclosed herein can be utilized, manufactured, installed, etc. using methods embodying aspects of the disclosed technology. Correspondingly, any description herein of particular features, capabilities, or intended purposes of a device or system should be considered to disclose, as examples of the disclosed technology a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, should be understood to disclose, as examples of the disclosed technology, the utilized features and implemented capabilities of such device or system.

The previous description of the disclosed examples is provided to enable any person skilled in the art to make or use the disclosure. Various modifications to these examples will be readily apparent to those skilled in the art, and the generic principles defined herein may be applied to other examples without departing from the spirit or scope of the disclosed technology. Thus, the disclosure is not intended to be limited to the examples shown herein but is to be accorded the widest scope consistent with the principles and novel features disclosed herein.

I claim:

1. A support assembly for electrical installations, the support assembly comprising:
a bracket, the bracket including:
a support body that includes:
one or more first slots;
one or more second slots that extend non-parallel to the one or more first slots; and
a clamp arm that extends integrally from the support body and is configured to clamp the bracket to a support structure;
the one or more first slots receiving one or more first fasteners and the one or more second slots receiving one or more second fasteners; and
the one or more first fasteners and the one or more second fasteners being slidably adjustable along the one or more first slots and the one or more second slots, respectively, to secure an electrical component to the bracket.

2. The support assembly of claim 1, further comprising the electrical component;
wherein the electrical component includes one or more first apertures spaced apart from one or more second apertures by any of a range of distances; and
the one or more first fasteners and the one or more second fasteners being slidable along the one or more first slots and the one or more second slots, respectively, to secure the electrical component to the bracket via alignment of the one or more first apertures and the one or more second apertures with the one or more first fasteners and the one or more second fasteners, respectively, at any of the range of distances.

3. The support assembly of claim 2, wherein the electrical component is a power switch box.

4. The support assembly of claim 1, wherein the one or more first slots include one or more substantially horizontal slots, and
wherein the one or more second slots include one or more substantially vertical slots.

5. The support assembly of claim 1, wherein the one or more first slots include a plurality of first slots, located along the support body between the one or more second slots and the clamp arm.

6. The support assembly of claim 5, wherein the one or more second slots includes only a single second slot.

7. The support assembly of claim 1, wherein the bracket includes an upper portion, and a lower portion that includes the clamp arm, the clamp arm extending away from the support body to define a lower surface that seats on a horizontal support structure to support the bracket relative to the horizontal support structure;
wherein the one or more first slots are included on the lower portion, and
wherein the one or more second slots are included on the upper portion.

8. The support assembly of claim 7, wherein the upper portion is narrower than the lower portion in a direction parallel with an elongate direction of the one or more first slots.

9. The support assembly of claim 7, wherein the support body extends at a lower end onto a lip that is opposite from, and angles towards, the clamp arm.

10. The support assembly of claim 1, wherein the clamp arm includes a first aperture and is configured to clamp the bracket to a horizontal support structure;
wherein an anchor feature extending integrally from the support body includes a second aperture; and
wherein the first and second apertures are aligned to receive a vertical support structure to support the bracket relative to the vertical support structure.

11. The support assembly of claim 10, wherein the support body includes a mounting stop that protrudes to be aligned with the first and second apertures, to block movement of the vertical support structure, through the first and second apertures, past an installed orientation.

12. The support assembly of claim 10, wherein the clamp arm supports a set screw opposite the support body to selectively: secure the horizontal support structure against the support body, or secure the vertical support structure within the first aperture.

13. The support assembly of claim 1, wherein the support body further includes a device cutout spaced laterally apart from the one or more first slots and the one or more second slots and configured to secure an electrical device to the support body adjacent to the electrical component.

14. The support assembly of claim 1, wherein the clamp arm and the support body collectively define a c-shaped clamp with an inwardly protruding lip.

15. A support assembly for electrical installations, the support assembly comprising:
a bracket that includes one or more first slots, one or more second slots that extend transverse to the one or more first slots, and a first anchor feature with a first aperture; and
fasteners received in the one or more first slots and the one or more second slots and slidably movable along the one or more first slots and the one or more second slots to selectively secure an electrical component having any of a plurality of different patterns of mounting holes that receive the fasteners;
the bracket being selectively securable to support the electrical component:
with the bracket in a first support configuration, in which the bracket engages a first support member, via clamping engagement of the first anchor feature with the first support member, to support the one or more electrical components relative to the first support member, the first support member extending along a first direction; and
with the bracket in a second support configuration, in which the bracket receives a second support member through the first aperture, to support the one or more electrical components relative to the second support member, the second support member extending along a second direction transverse to the first direction.

16. The support assembly of claim 15, wherein the bracket further includes a second anchor feature with a second aperture, the second anchor feature being spaced from the first anchor feature along the second direction and aligning the second aperture to also receive the second support member in the second support configuration.

17. The support assembly of claim 15, wherein the first anchor feature includes a clamp arm extending integrally from a support plate; and
wherein the support plate extends to a first end that includes an angled lip aligned opposite the clamp arm to engage the first support member in the first support configuration.

18. The support assembly of claim 15, wherein the first anchor feature includes a clamp arm that protrudes from a support body of the bracket to support a set screw, the set screw being aligned to clamp the first support member against the support body in the first support configuration and to clamp the second support member within the first aperture in the second support configuration.

19. A method of installing a support assembly for electrical installations, the method comprising:
slidably moving fasteners within one or more first slots and one or more second slots of a bracket to selectively secure one or more electrical components having different patterns of mounting holes that receive the fasteners, the one or more second slots extending transverse to the one or more first slots; and
selectively securing the bracket to support the one or more electrical components:with the bracket in a first support configuration, in which the bracket engages a first support member that extends along a first direction, via clamping engagement of a first anchor feature of the bracket with the first support member, to support the one or more electrical components relative to the first support member; or with the bracket in a second support configuration, in which the bracket receives a second support member through a first aperture of the first anchor feature, the second support member extending along a second direction transverse to the first direction, to support the one or more electrical components relative to the second support member.

20. The method of claim 19, wherein securing the bracket in the first support configuration includes tightening a set screw supported by a clamp arm of the first anchor feature to secure the first support member against a support body of the bracket; and
wherein securing the bracket in the second support configuration includes tightening the set screw to secure the second support member against an edge wall of the first aperture.
